(19) United States
(12) Patent Application Publication
(10) Pub. No.: US 2009/0009618 A1
(43) Pub. Date: Jan. 8, 2009

(54) Analog front-end circuit, semiconductor device, and electronic instrument

(75) Inventors: Tomonaga Hasegawa, Sapporo (JP); Masahiko Mizuta, Sapporo (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 12/070,317

(22) Filed: Feb. 18, 2008

(30) Foreign Application Priority Data
Feb. 19, 2007 (JP) 2007-037824

(51) Int. Cl. H04N 5/228

(52) U.S. Cl. 348/222.1; 348/E05.062

(57) ABSTRACT

An analog front-end circuit includes an analog processing circuit, an A/D converter, and a timing generator that generates a plurality of control signals that are supplied to an image sensor. The timing generator includes an event information memory, and a control signal output circuit that generates the control signals based on information read from the event information memory and outputs the generated control signals. The event information memory stores a pixel number and change event occurrence information at each address. The change event occurrence information specifies a control signal that undergoes a signal level change event at the pixel number. The control signal output circuit generates the control signals based on the pixel number and the change event occurrence information read from the event information memory and outputs the generated control signals.

Japanese Patent Application No. 2007-37824 filed on Feb. 19, 2007, is hereby incorporated by reference in its entirety.

### BACKGROUND OF THE INVENTION

The present invention relates to an analog front-end circuit, a semiconductor device, an electronic instrument, and the like.

In an image sensor such as a CCD or CMOS sensor used for electronic instruments such as an image reader, an image signal (stored charge) obtained by a light-receiving section of the image sensor is transferred from the light-receiving section to a transfer section based on a shift signal supplied to the image sensor. The image signal is sequentially shifted by the transfer section based on a drive clock signal and is output to the outside.

JP-A-2004-297146 discloses related-art technology relating to a circuit which generates image sensor control signals such as a shift signal (shift clock signal) and a drive clock signal. In Patent Document 1, the shift signal is generated by setting the signal change timing (i.e., rising edge or falling edge) of the shift signal in a timing setting register.

According to this related-art method, control signal change events can be generated only in a number corresponding to the number of timing setting registers. Therefore, it is necessary to increase the number of timing setting registers in order to deal with various image sensors which differ in control signal change timing. This results in an increase in circuit scale. Moreover, since the circuit must be changed depending on the image sensor, an increase in development period, an increase in development cost, or the like occurs.

### SUMMARY

According to one aspect of the invention, there is provided an analog front-end circuit comprising:

an analog processing circuit that receives an analog input image signal from an image sensor, performs a given process on the analog input image signal, and outputs an analog image signal;

an A/D converter that A/D-converts the analog image signal output from the analog processing circuit; and

a timing generator that generates a plurality of control signals that are supplied to the image sensor,

the timing generator including:

an event information memory; and

a control signal output circuit that generates the plurality of control signals based on information read from the event information memory, and outputs the plurality of control signals that have been generated,

the event information memory storing a pixel number and change event occurrence information at each address, the change event occurrence information specifying a control signal among the plurality of control signals that undergoes a signal level change event at the pixel number; and

the control signal output circuit generating the plurality of control signals based on the pixel number and the change event occurrence information read from the event information memory, and outputting the plurality of control signals that have been generated.

According to another aspect of the invention, there is provided a semiconductor device comprising the above analog front-end circuit.

According to another aspect of the invention, there is provided an electronic instrument comprising:

the above analog front-end circuit; and

an image sensor.

According to another aspect of the invention, there is provided an electronic instrument comprising:

a head-side board provided with the above analog front-end circuit and an image sensor; and

a main board provided with an image processing section that processes digital image data output from the analog front-end circuit.

### BRIEF DESCRIPTION OF THE SEVERAL VIEWS OF THE DRAWING

FIGS. 1A to 1C are views illustrative of an image sensor.

FIG. 2 is a view illustrative of a timing setting method according to a comparative example.

FIG. 3 shows a configuration example of an analog front-end circuit according to one embodiment of the invention.

FIG. 4 is a view illustrative of the memory space of an event information memory.

FIG. 5 is a view illustrative of each bit of an event information memory.

FIG. 6 shows an example of a signal waveform generated using a method according to one embodiment of the invention.

FIG. 7 is a view illustrative of a control signal clear process.

FIG. 8 is a view illustrative of a drive clock signal pattern memory.

FIG. 9 shows an example of a signal waveform generated using the pattern memory shown in FIG. 8.

FIG. 10 shows a signal waveform example of a drive clock signal supplied to an image sensor and an output image signal.

FIG. 11 shows a configuration example of a control signal output circuit.

FIG. 12 shows a configuration example of an analog processing circuit.

FIG. 13 shows a configuration example of an electronic instrument.

### DETAILED DESCRIPTION OF THE EMBODIMENT

Aspects of the invention may provide an analog front-end circuit which enables efficient generation of control signals, a semiconductor device, and an electronic instrument including the same.

According to one embodiment of the invention, there is provided an analog front-end circuit comprising:

an analog processing circuit that receives an analog input image signal from an image sensor, performs a given process on the analog input image signal, and outputs an analog image signal;

an A/D converter that A/D-converts the analog image signal output from the analog processing circuit; and

a timing generator that generates a plurality of control signals that are supplied to the image sensor,

the timing generator including:

an event information memory; and

a control signal output circuit that generates the plurality of control signals based on information read from the event information memory, and outputs the plurality of control signals that have been generated,

the event information memory storing a pixel number and change event occurrence information at each address, the change event occurrence information specifying a control signal among the plurality of control signals that undergoes a signal level change event at the pixel number; and

the control signal output circuit generating the plurality of control signals based on the pixel number and the change event occurrence information read from the event information memory, and outputting the plurality of control signals that have been generated.

According to this embodiment, the pixel number and the change event occurrence information are stored at each address of the event information memory while being associated with each other. A control signal that undergoes the signal level change event at the pixel number is specified by the change event occurrence information, and the control signals for the image sensor are generated based on the change event occurrence information and the pixel number. The control signals can be efficiently generated, even if the change event relating to the signal level of the control signal occurs frequently, by generating the control signals using the event information memory.

In the analog front-end circuit, the pixel number may be allocated to first to Lth bits of data stored at each address of the event information memory, and the change event occurrence information may be allocated to (L+1)th to Mth (L<M; L and M are natural numbers) bits of the data stored at each address of the event information memory.

According to this configuration, the pixel number and the change event occurrence information can be easily associated.

In the analog front-end circuit, first to (M-L)th control signals among the plurality of control signals may be respectively allocated to the (L+1)th to Mth bits of the data stored at each address of the event information memory.

According to this configuration, the change event occurrence information relating to the plurality of control signals can be set using the (L+1)th to Mth bits of the data at each address.

In the analog front-end circuit, when an Nth (L+1≦N≦M; L, N, and M are natural numbers) bit of the (L+1)th to Mth bits is set at a first logic level, the control signal output circuit may toggle a signal level of a control signal among the plurality of control signals that is allocated to the Nth bit.

The timing of the control signal can be easily set using the event information memory by generating the control signals by toggling the signal level using the change event occurrence information.

In the analog front-end circuit, the control signal output circuit may sequentially read the pixel number and the change event occurrence information in an order from a head address to an end address of the event information memory, and may return a read pointer of the event information memory to the head address before the end address is reached when at least one of the pixel number and the change event occurrence information that have been read is set to finish indication information that indicates that the change event has finished.

This prevents a situation in which the pixel number and the change event occurrence information are unnecessarily read even if the change event does not occur, whereby the process efficiency can be increased.

In the analog front-end circuit, the control signal output circuit may sequentially read the pixel number and the change event occurrence information in an order from a head address to an end address of the event information memory, and may return a read pointer of the event information memory to the head address when the end address has been reached.

In the analog front-end circuit,

the event information memory may store toggle indication information as the change event occurrence information, the toggle indication information indicating to toggle a signal level of a control signal among the plurality of control signals; and

the control signal output circuit may clear signal levels of the plurality of control signals to a first signal level when the read pointer has been returned to the head address and processing of pixels of a next line starts.

According to this configuration, a change in the control signal immediately returns to a normal state even if a toggle error has occurred.

In the analog front-end circuit,

the event information memory may store change event occurrence information relating to a shift signal that causes a transfer gate of the image sensor to be turned ON; and

the control signal output circuit may generate the shift signal based on the change event occurrence information relating to the shift signal that has been read from the event information memory, and may output the shift signal that has been generated.

It is possible to implement an analog front-end circuit which can easily deal with various image sensors by generating the shift signal in this manner.

In the analog front-end circuit,

the control signal output circuit may generate a drive clock signal that is used to drive the image sensor, and may output the drive clock signal that has been generated;

the event information memory may store change event occurrence information relating to a clock control signal that controls an output state of the drive clock signal; and

the control signal output circuit may generate the clock control signal based on the change event occurrence information relating to the clock control signal that has been read from the event information memory, and may control the output state of the drive clock signal based on the clock control signal that has been generated.

The drive clock signals with various output patterns which differ depending on the image sensor can be efficiently generated by generating the clock control signal and controlling the output state of the drive clock signal.

In the analog front-end circuit, the control signal output circuit may output the drive clock signal with a normal-state clock signal pattern when the clock control signal is set in a first state, and may output the drive clock signal with a skip-state clock signal pattern when the clock control signal is set in a second state.

A transfer can be fast-forwarded for an ineffective pixel or the like by outputting the drive clock signal with a skip-state clock signal pattern, whereby the image sensor can be efficiently driven.

In the analog front-end circuit, the control signal output circuit may output the drive clock signal with a normal-state clock signal pattern when the clock control signal is set in a first state, and may output the drive clock signal set at a fixed value level when the clock control signal is set in a third state.

The drive clock signal can be set at an arbitrary fixed value level in an arbitrary period when driving the image sensor by setting the drive clock signal at the fixed value level, whereby the image sensor can be appropriately driven.

In the analog front-end circuit,

the event information memory may store change event occurrence information relating to a black reference pixel indication signal that specifies a position of a black reference pixel of the image sensor; and

the control signal output circuit may generate the black reference pixel indication signal based on the change event occurrence information relating to the black reference pixel indication signal that has been read from the event information memory, and may output the black reference pixel indication signal that has been generated.

This enables the black reference pixel position to be specified, so that the image sensor can be efficiently driven.

In the analog front-end circuit,

the event information memory may store change event occurrence information relating to a white pixel indication signal that specifies a position of a white pixel of the image sensor; and

the control signal output circuit may generate the white pixel indication signal based on the change event occurrence information relating to the white pixel indication signal that has been read from the event information memory, and may output the white pixel indication signal that has been generated.

This enables the white pixel position to be specified, so that the image sensor can be efficiently driven.

In the analog front-end circuit,

the control signal output circuit may include:

a pixel counter that counts a pixel count value;

a comparison circuit that compares the pixel number read from the event information memory with the pixel count value output from the pixel counter; and

a signal generation circuit that generates the plurality of control signals when the pixel number coincides with the pixel count value, the signal generation circuit generating the plurality of control signals based on the change event occurrence information stored at an address of the pixel number that coincides with the pixel count value.

According to this configuration, the control signals can be generated by reading the change event information associated with the pixel number at each address of the event information memory from the event information memory using a simple process.

According to another embodiment of the invention, there is provided a semiconductor device comprising one of the above analog front-end circuits.

According to another embodiment of the invention, there is provided an electronic instrument comprising:

one of the above analog front-end circuits; and

an image sensor.

According to another embodiment of the invention, there is provided an electronic instrument comprising:

a head-side board provided with one of the above analog front-end circuits and an image sensor; and

a main board provided with an image processing section that processes digital image data output from the analog front-end circuit.

Preferred embodiments of the invention are described below in detail. Note that the embodiments described below do not in any way limit the scope of the invention defined by the claims laid out herein. Note that all elements of the embodiments described below should not necessarily be taken as essential requirements for the invention.

1. Image Sensor

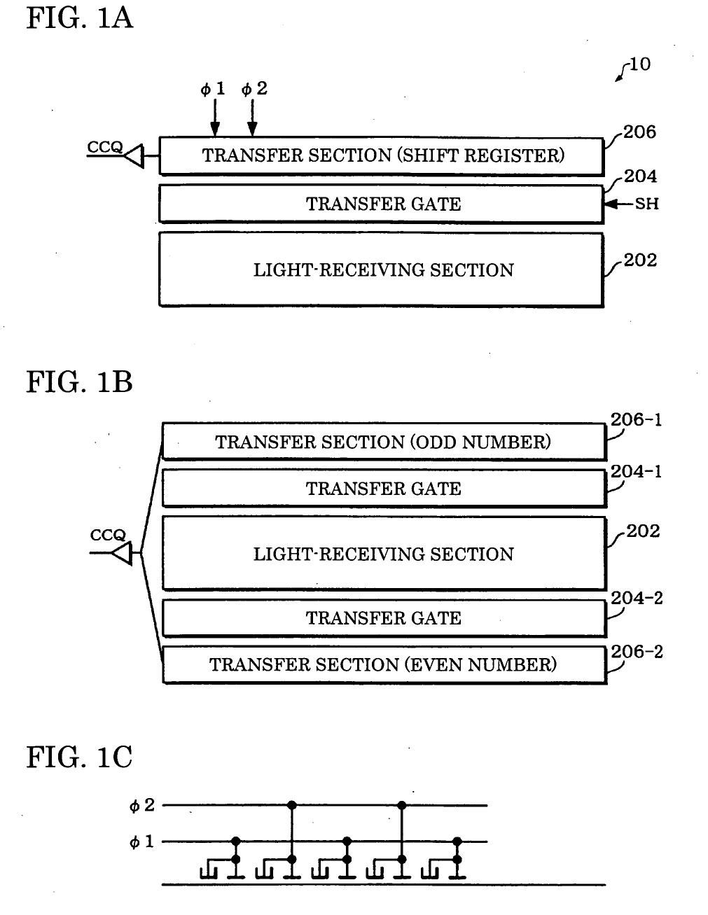

FIG. 1A shows a configuration example of an image sensor 10. The image sensor 10 (e.g., CCD line sensor) includes a light-receiving section 202, a transfer gate 204, and a transfer section 206 (shift register). The light-receiving section 202 includes a plurality of light-receiving elements (photodiodes or pixels) which perform photoelectric conversion.

Each light-receiving element (pixel) of the light-receiving section 202 produces and stores a charge corresponding to the amount of received light. A shift signal SH becomes active after a specific period of time required for charge storage has expired so that the transfer gate 204 is turned ON. As a result, the stored charge is transferred to a shift register (shift register provided corresponding to each light-receiving element) of the transfer section 206 through the transfer gate 204. The stored charge (image signal) transferred to each shift register is transferred to the adjacent shift registers based on two-phase drive clock signals φ1 and φ2. This causes an image signal corresponding to the charge stored in each light-receiving element to be serially output from a CCQ terminal of the image sensor 10.

Note that the configuration of the image sensor 10 is not limited to the configuration shown in FIG. 1A. Various modifications and variations may be made. As shown in FIG. 1B, it is desirable to provide a transfer gate 204-1 and a transfer section 206-1 for odd-numbered pixels and a transfer gate 204-2 and a transfer section 206-2 for even-numbered pixels, for example. In the configurations shown in FIGS. 1A and 1B, it is desirable to provide light-receiving sections, transfer gates, and transfer sections for reading an R (red), G (green), and B (blue) image. FIG. 1C shows a configuration example of the shift register of the transfer section 206.

2. Configuration of Analog Front-End Circuit

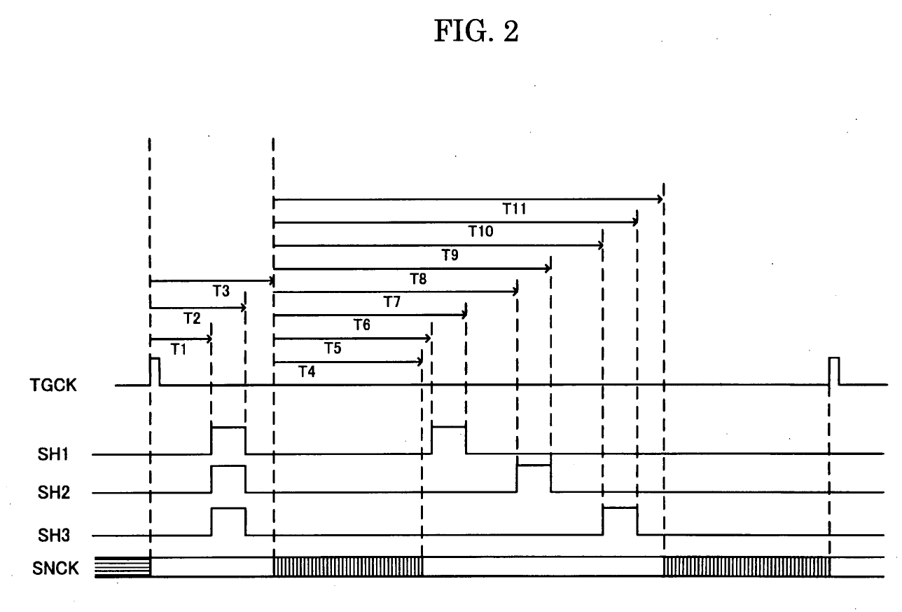

FIG. 2 shows a timing setting method according to a comparative example of this embodiment. According to this method, each piece of timing information T1 to T11 shown in FIG. 2 is set in a timing setting register, for example. For example, the timing information T1 sets a period from the rise timing of a trigger signal TGCK (shift signal trigger signal) which indicates the start of processing one line to the first rise timing of shift signals SH1 to SH3 (shift pulse signals). The timing information T2 sets a period from the rise timing of the trigger signal TGCK to the first fall timing of the shift signals SH1 to SH3. The shift signals SH1, SH2, and SH3 respectively indicate R, G and B shift signals, for example.

According to the comparative example method shown in FIG. 2, the circuit scale increases since the timing setting registers are required in a number corresponding to the number of pieces of timing information T1 to T11.

Moreover, when the change timing a of the shift signals SH1 to SH3 are changed due to a change in the type of image sensor, the number of timing setting registers increases, or the period specified by the timing information changes, whereby the circuit must be changed, for example. In FIG. 2, since the first rise timings of the shift signals SH1 to SH3 occur at the same time, the timings of the shift signals SH1 to SH3 are set using the timing information T1, for example. However, when the shift signals SH1 to SH3 differ in the first rise timing due to a change in the image sensor, the timings of the shift signal SH1 to SH3 cannot be specified using only the timing information T1. Therefore, the timing information must be changed, whereby a change in circuit or the like is required.

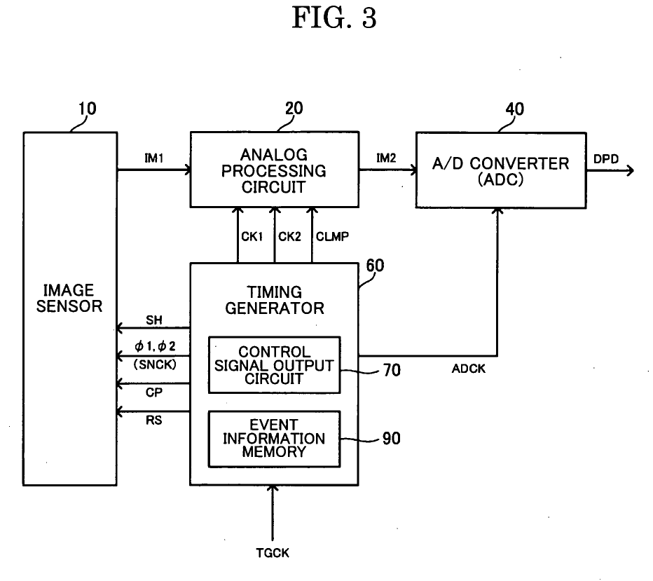

FIG. 3 shows a configuration example of an analog front-end circuit (image processing device or image processing controller) according to this embodiment which can solve the above-mentioned problems. This analog front-end circuit (AFE) includes an analog processing circuit 20, an A/D converter 40, and a timing generator 60. Note that the analog front-end circuit according to this embodiment is not limited to the configuration shown in FIG. 3. Various modifications may be made such as omitting some elements (e.g., A/D processing circuit) or adding other elements (e.g., host interface, image data transmitter circuit, or PLL circuit).

The analog processing circuit 20 receives an analog input image signal IM1 from the image sensor 10 (line sensor) such as a CCD. The analog processing circuit 20 performs a given process (preprocess before A/D conversion) on the input image signal IM1, and outputs an analog image signal IM2. Specifically, the analog processing circuit 20 performs an offset adjustment process or a gain control process on the image signal IM1 as the given process, for example. Alternatively, the analog processing circuit 20 may perform a clamping process which sets the image signal IM1 at a given clamping level, correlated double sampling (CDS), an image signal sampling process, or the like.

The A/D converter 40 A/D-converts the image signal IM2 output from the analog processing circuit 20. The A/D converter 40 outputs digital image data DPD. As the A/D converter 40, a pipeline A/D converter having a plurality of cascaded pipeline stages may be used, for example. Each pipeline stage of the pipeline A/D converter quantizes the input image signal using a sub-A/D converter to convert the input image signal into digital data, and D/A-converts the digital data using a sub-D/A converter. Each pipeline stage subjects the input image signal and the analog signal obtained using the sub-D/A converter to a subtraction process, amplifies the resulting signal, and outputs the amplified signal to the subsequent pipeline stage. The A/D converter 40 is not limited to the pipeline A/D converter. The A/D converter 40 may be another type of A/D converter known in the art.

The timing generator 60 generates a plurality of control signals supplied to the image sensor 10. The control signals generated by the timing generator 60 include drive signals for the image sensor 10 and drive signals (control signals) for the analog front-end circuit, for example.

The drive signals for the image sensor 10 include the shift signal SH, the drive clock signals φ1 and φ2 (SNCK), a clamping signal CP, a reset signal RS, and the like. The timing generator 60 generates the drive signals SH, φ1, φ2, CP, RS and the like, and supplies the generated drive signals to the image sensor 10 to drive (control) the image sensor 10.

The drive signals for the analog front-end circuit include an A/D conversion clock signal (reference clock signal) ADCK, sampling clock signals CK1 and CK2, a clamping signal CLMP, and the like. The timing generator 60 generates the clock signal ADCK, and supplies the clock signal ADCK to the A/D converter 40. The timing generator 60 generates the sampling clock signals CK1 and CK2 and the clamping signal CLMP, and supplies the sampling clock signals CK1 and CK2 and the clamping signal CLMP to the analog processing circuit 20.

The timing generator 60 includes a control signal output circuit 70 and an event information memory 90.

The control signal output circuit 70 generates the control signals based on information read from the event information memory 90 (RAM), and outputs the generated control signals, for example. The event information memory 90 stores a pixel number (pixel number identification information) and control signal change event occurrence information (toggle indication information) associated with the pixel number at each address. The control signal output circuit 70 generates the control signals (e.g., shift signals SH (SH1 to SH6 and SHX) and the clock control signal) based on the pixel number and the change event occurrence information read from the event information memory 90.

The pixel number (pixel count or pixel position) stored in the event information memory 90 is information which specifies the position of each pixel of the image sensor 10. The pixel number is arbitrary. The change event occurrence information (event information) stored in the event information memory 90 is information which designates (specifies) a control signal that undergoes a signal level change event at the pixel number associated with the change event occurrence information (i.e., pixel number stored at the same address).

Suppose that the signal level of the ith control signal among a plurality of control signals has changed at an jth pixel number (pixel position), for example. For example, the ith control signal has changed from the L level (“0”) to the H level (“1”) or changed from the H level to the L level. In this case, the jth pixel number is stored at the kth address of the event information memory 90, and the change event occurrence information (change event occurrence bit) which is information (bit) that designates (specifies) the ith control signal is also stored at the kth address of the event information memory 90 while being associated with the jth pixel number.

It is possible to deal with the case where a change event relating to the signal level of the control signal frequently occurs using a relatively small circuit configuration by providing such an event information memory 90.

In the comparative example shown in FIG. 2, the timing setting registers are required in a number corresponding to the number of signal level change events. According to this embodiment, signal level change events can be set in a number corresponding to at least the address volume (depth) of the event information memory 90. Therefore, the number of control signal change points can be increased, whereby it is possible to deal with various image sensors. Moreover, since the user can change the signal change point merely by rewriting the information stored in the event information memory 90, a change in circuit accompanying a change in signal change point can be minimized.

3. Event Information Memory

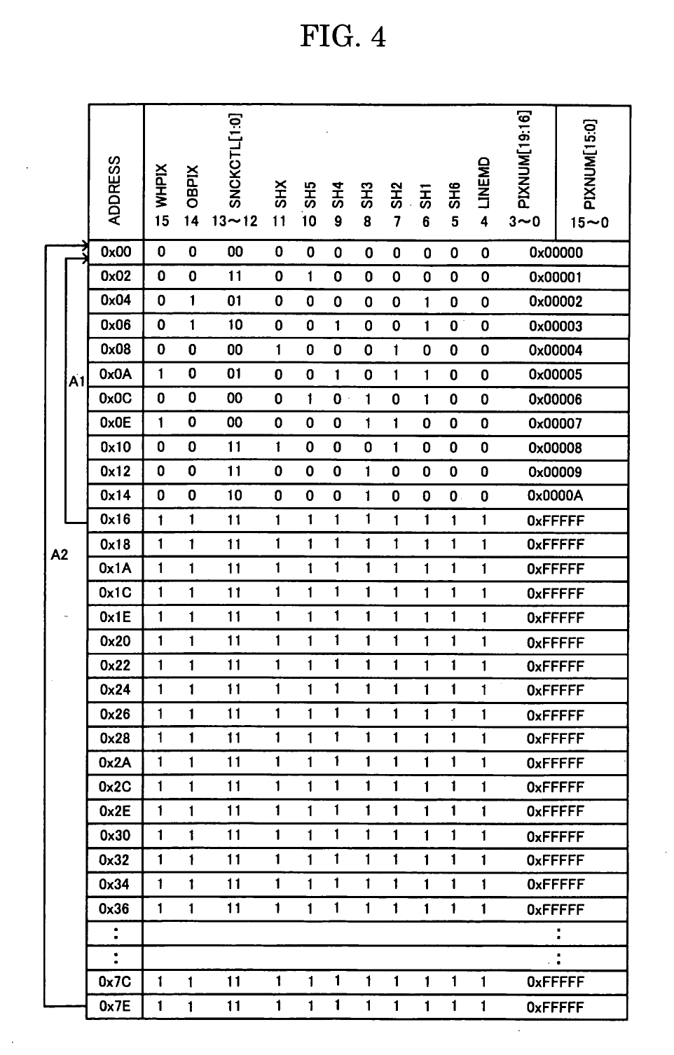

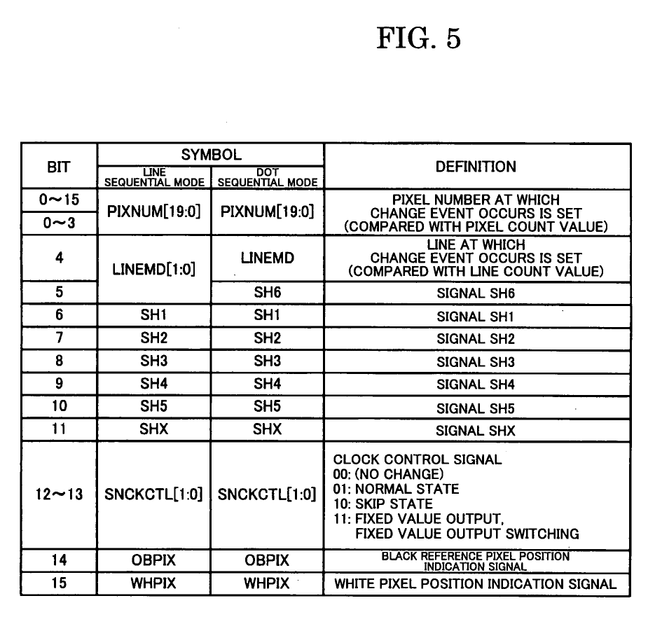

A control signal timing setting method using the event information memory 90 is described below. FIG. 4 shows an example of the memory space of the event information memory 90. FIG. 5 shows an example of signal allocation to each bit.

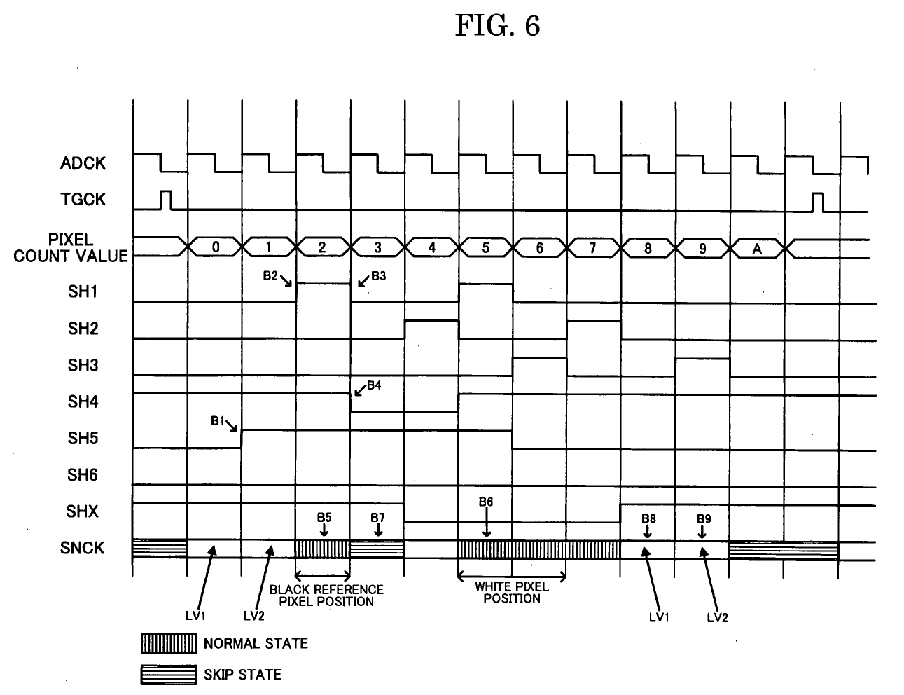

FIG. 6 shows an example of a signal waveform generated using the setting method shown in FIGS. 4 and 5.

In FIG. 4, the data of each event (signal level change event) is set in units of two words (16 bits). The address of the event information memory 90 changes in units of two words (0x02). The data of each event is associated with addresses 0x00, 0x02, 0x04, . . . , 0x7C, and 0x7E.

As shown in FIG. 4, a pixel number PIXNUM[19:0] is allocated to bits 0 to 15 of the first word and bits 0 to 3 (first to Lth bits in a broad sense; L is an integer equal to or larger than two) of the second word of the data stored at each address of the event information memory 90. The change event occurrence information (toggle indication bit) of the control signals SH1 to SH6, SHX, SNCKCTL, OBPIX, and WHPIX is allocated to bits 4 to 15 ((L+1)th to Mth bits in a broad sense; M is an integer equal to or larger than two) of the second word of the data stored at each address. The bit allocation of the pixel number and the change event occurrence information is not limited to the example shown in FIG. 4. Various modifications and variations may be made such as changing the order of bit allocation.

In FIG. 4, the control signals SH1 to SH6, SHX, SNCKCTL, OBPIX, and WHPIX are allocated to bits 4 to 15 ((L+1)th to Mth bits) of the data at each address. For example, a line number LINEMD is allocated to bit 4, the control signals SH6, SH1 to SH5, and SHX are allocated to bits 5 to 11, the control signal SNCKCTL is allocated to bits 12 and 13, the control signal OBPIX is allocated to bit 14, and the control signal WHPIX is allocated to bit 15.

When each bit of the bits 4 to 15 (Nth bit of the (L+1)th to Mth bits; L+1≦N≦M) is set at “1” (first logic level in a broad sense), the control signal output circuit 70 toggles the signal level of the control signal allocated to that bit (Nth bit).

For example, bit 10 is set at “1” (first logic level) at the address 0x02 shown in FIG. 4. In this case, the signal level of the signal SH5 allocated to bit 10 is toggled, as indicated by B1 in FIG. 6. Specifically, the signal level changes from the L level to the H level. Bit 6 is set at “1” at the address 0x04 shown in FIG. 4. In this case, the signal level of the signal SH1 allocated to bit 6 is toggled, as indicated by B2 in FIG. 6. Specifically, the signal level changes from the L level to the H level. Bit 6 is set at “1” at the address 0x06. Therefore, the signal level of the signal SH1 allocated to bit 6 is toggled, as indicated by B3 in FIG. 6. In this case, the signal level changes from the H level to the L level.

The control signal timing setting using the event information memory 90 is simplified utilizing the toggle indication information (toggle indication bit) as the change event occurrence information stored in the event information memory 90. This improves convenience to the user.

Note that a method which does not utilize the toggle indication information may also be employed. In FIG. 4, bit 10 corresponding to the signal SH5 is set at “0100001 . . . ” in order to set the waveform of the signal SH5 shown in FIG. 6, for example. It is also possible to set bit 10 corresponding to the signal SH5 at “10111110 . . . ”.

4. Generation of Shift Signal

In this embodiment, the shift signals SH1 to SH6 and SHX (hereinafter appropriately referred to as “shift signal SH”) are generated as the control signals generated based on the event information memory 90. Specifically, the event information memory 90 stores the change event occurrence information relating to the shift signal SH which causes the transfer gate 204 of the image sensor shown in FIG. 1A to be turned ON. The control signal output circuit 70 generates the shift signal SH based on the change event occurrence information relating to the shift signal SH read from the event information memory 90, and outputs the generated shift signal SH.

In FIG. 4, the pixel number and the change event occurrence information are sequentially read in the order from the head address 0x00 to the end address 0x7E of the event information memory 90, for example. Specifically, the pixel number PIXNUM=0x00000 stored at the head address 0x00 is read, and the read pixel number is compared with a pixel count value (count value of pixel counter described later) shown in FIG. 6. When the pixel number coincides with the pixel count value, the signal level of the control signal is set based on bits 4 to 15 which indicate the change event occurrence information stored at the address 0x00. In this case, since bits 4 to 15 are set at “0” (second logic level) (i.e., do not indicate toggle), the signal level of the control signal is not changed.

The pixel number PIXNUM=0x00001 stored at the address 0x02 is then read and compared with the pixel count value shown in FIG. 6. When the pixel number coincides with the pixel count value, the signal level of the control signal is set based on bits 4 to 15 (change event occurrence information) at the address 0x02. In this case, since bit 10 is set at “1”, the shift signal SH5 is changed from the L level to the H level, as indicated by B1 in FIG. 6.

The pixel number PIXNUM=0x00002 stored at the address 0x04 is then read and compared with the pixel count value. When the pixel number coincides with the pixel count value, the signal level of the control signal is set based on bits 4 to 15 at the address 0x04. In this case, since bit 6 is set at “1”, the shift signal SH1 is changed from the L level to the H level, as indicated by B2 in FIG. 6.

Likewise, the pixel number PIXNUM=0x00003 and bits 4 to 15 are read from the address 0x06, and the shift signals SH1 and SH4 are changed from the H level to the L level, as indicated by B3 and B4 in FIG. 6.

In FIG. 4, the pixel numbers PIXNUM stored at the addresses 0x00, 0x02, 0x04, . . . are incremented by one, such as 0x00000, 0x00001, 0x00002, 0x00003, . . . for convenience of description. Note that the pixel numbers PIXNUM may be incremented in an arbitrary manner. For example, the pixel numbers PIXNUM may be incremented by two or more, such as 0x00000, 0x00002, . . . , or may be incremented randomly, such as 0x0000, 0x00002, 0x00006, . . . .

It is possible to easily deal with various image sensors by generating the shift signal using the above-described method. Suppose that the first rise timings of the shift signals SH1 to SH3 (R, G, and B shift signals) shown in FIG. 2 are the same in a first image sensor and differ in a second image sensor, for example. According to this embodiment, it is possible to easily deal with the first and second image sensors merely by rewriting the data stored in the event information memory 90. Therefore, a change in circuit or the like can be minimized, whereby the development period and the development cost can be reduced.

At the address 0x16 and the subsequent addresses in FIG. 4, the pixel number (PIXNUM) is set at 0xFFFFF which is finish indication information (finish indication number) indicating that the change event has finished. The change event occurrence information at the bits 4 to 15 is set at 0xFFF which is the finish indication information.

For example, the pixel number and the change event occurrence information are sequentially read in the order from the head address 0x00 to the end address 0x7E of the event information memory 90. When the pixel number and the change event occurrence information which have been read are set to the finish indication information (0xFFFFF and 0xFFF) such as at the address 0x16, the control signal output circuit 70 (read circuit) returns a read pointer of the event information memory 90 to the head address 0x00 before the end address 0x7E is reached, as indicated by A1 in FIG. 4.

This prevents a situation in which the pixel number and the change event occurrence information are unnecessarily read even if a change event does not occur, whereby the process efficiency can be increased. For example, the number of signal level change events may differ depending on the image sensor. In this case, the information relating to the change event can be efficiently stored in the event information memory 90 using the method which detects the finish indication information and returns the read pointer, as indicated by A1 in FIG. 4. Moreover, the efficiency of the information read process can be increased.

When the finish indication information (0xFFFFF and 0xFFF) is not set, for example, the read pointer of the event information memory 90 may be returned to the head address 0x00 when the end address 0x7E has been reached, as indicated by A2 in FIG. 4.

When processing the pixels of the next line after the read pointer has been returned to the head address 0x00, as indicated by A1 and A2 in FIG. 4, it is desirable to clear the signal level of the control signal to the L level (first signal level in a broad sense).

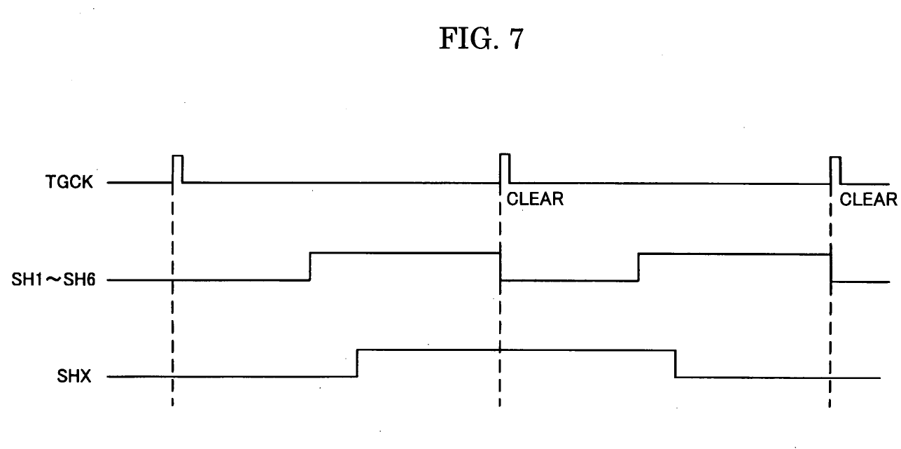

In FIG. 7, the pixels of the first line of the line image sensor are processed when the trigger signal TGCK has become active, and the signal levels of the shift signals SH1 to SH6 are changed using the method according to this embodiment, for example. When the read pointer has been returned to the head address 0x00, as indicated by A1 and A2 in FIG. 4, and the trigger signal TGCK has again become active so that processing of the pixels of the next line has started, the shift signals SH1 to SH6 are cleared to the L level.

For example, when the change event occurrence information stored in the event information memory 90 is the toggle indication information (toggle indication bit) described with reference to FIG. 4, incorrect shift signals SH1 to SH6 may be generated if the signal level clear process shown in FIG. 7 is not performed. Suppose that the signal levels of the signals SH1 to SH6 are erroneously toggled due to noise or the like. In this case, the signals SH1 to SH6 which should change from the L level to the H level every line, as shown in FIG. 7, change from the H level to the L level every line after a toggle error has occurred.

A change in the signals SH1 to SH6 immediately returns to a normal state, even if a toggle error has occurred, by performing the signal level clear process shown in FIG. 7, so that the reliability of the signal generation process can be increased.

Note that the signal SHX is not cleared, differing from the signals SH1 to SH6. A change in signal level across two lines shown in FIG. 7 can be implemented using the signal SHX, so that the degree of variety of the control signals to be generated can be increased.

5. Generation of Clock Control Signal

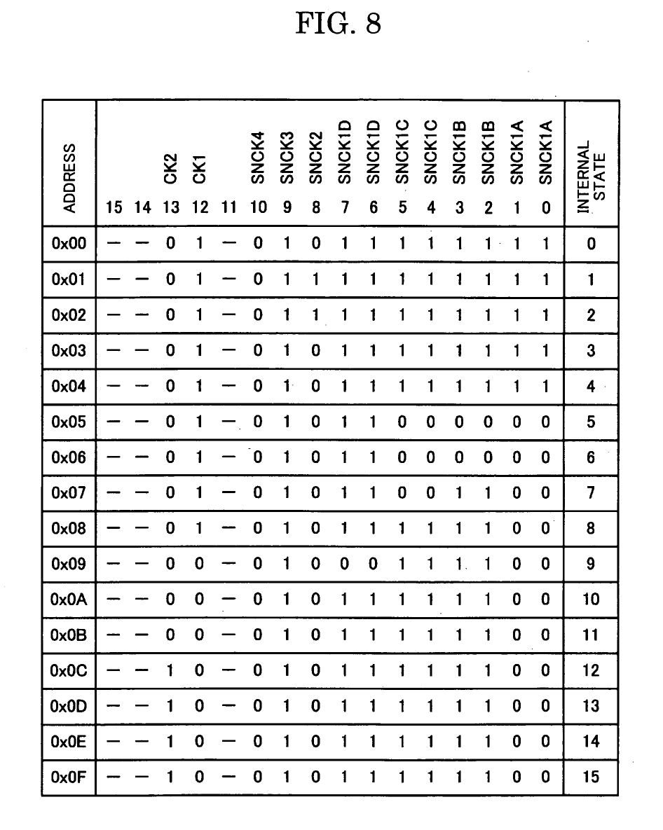

In this embodiment, the event information memory 90 stores the change event occurrence information relating to the clock control signal SNCKCTL which controls the output state (output pattern) of the drive clock signal of the image sensor, as shown in FIG. 4. The control signal output circuit 70 generates the clock control signal SNCKCTL based on the change event occurrence information read from the event information memory 90. The control signal output circuit 70 controls the output state of the drive clock signal based on the generated clock control signal SNCKCTL. For example, the control signal output circuit 70 generates drive clock signals SNCK1A to SNCK4 (hereinafter appropriately referred to as “drive clock signal SNCK”) of the image sensor using a pattern memory shown in FIG. 8.

In FIG. 8, an internal state value is incremented from 0 to 15, and the internal state value is also incremented from 0 to 15 in the next cycle, for example. A period in which the internal state value is incremented from 0 to 15 is a period of one pixel. Specifically, the internal state value is also incremented from 0 to 15 in a period in which the pixel count value shown in FIG. 6 is incremented by one.

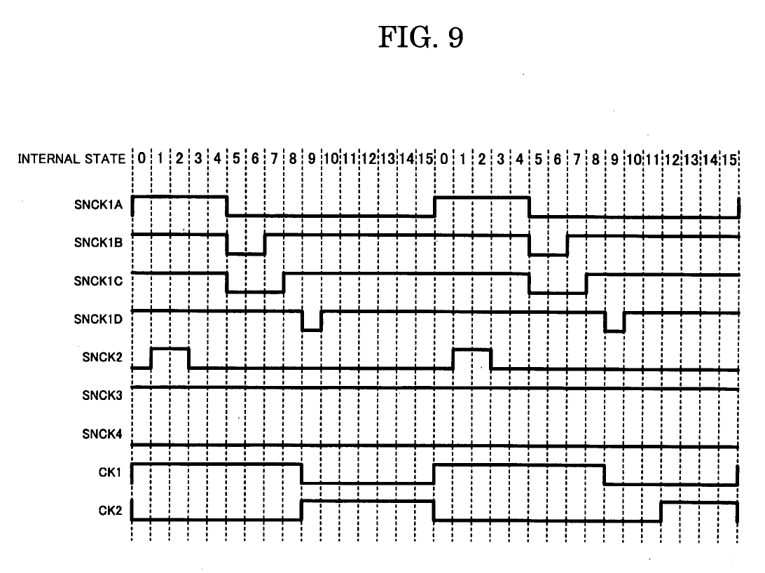

In FIG. 8, clock signal pattern information relating to the drive clock signal is read from each address of the drive clock signal pattern memory each time the internal state value is incremented, and the drive clock signal SNCK is generated based on the clock signal pattern information read from the pattern memory. FIG. 9 shows a signal waveform example of the drive clock signal SNCK (φ1 and φ2 and the like shown in FIG. 1A) generated using the pattern memory shown in FIG. 8.

The clock control signal SNCKCTL controls the output state of the drive clock signal SNCK generated in this manner.

As shown in FIG. 4, the signal SNCKCTL is set at “01” (first state in a broad sense) at the address 0x04 where the pixel number (PIXNUM) is set at 0x00002, for example. As shown in FIG. 5, “01” means a normal state (during effective pixel output). Therefore, when the signal SNCKCTL is set at “01” (first state), the drive clock signal SNCK with a normal-state clock signal pattern is output from the control signal output circuit 70, as indicated by B5 in FIG. 6. Specifically, the normal-state effective pixel (including a black reference pixel) drive clock signal SNCK shown in FIGS. 8 and 9 is generated and output. Likewise, since the signal SNCKCTL is set at “01” at the address 0x0A where the pixel number is set at 0x00005, the drive clock signal SNCK with a normal-state clock signal pattern is output from the control signal output circuit 70, as indicated by B6 in FIG. 6.

The signal SNCKCTL is set at “10” (second state in a broad sense) at the address 0x06 where the pixel number is set at 0x00003. As shown in FIG. 5, “10” means a skip state. Therefore, when the signal SNCKCTL is set at “10” (second state), the drive clock signal SNCK with a skip-state clock signal pattern is output, as indicated by B7 in FIG. 6.

A transfer can be fast-forwarded for an ineffective pixel between a black reference pixel and a white pixel (effective pixel) by outputting the drive clock signal SNCK with a skip-state clock signal pattern, whereby the drive efficiency of the image sensor can be increased.

The signal SNCKCTL is set at “11” (third state in a broad sense) at the address 0x10 where the pixel number is set at 0x00008. As shown in FIG. 5, “11” means a fixed value output (fixed value output switching). Therefore, when the signal SNCKCTL is set at “11” (third state), the drive clock signal SNCK set at a fixed value level LV1 is output, as indicated by B8 in FIG. 6.

The signal SNCKCTL is also set at “11” at the address 0x12 where the pixel number is set at 0x00009. Therefore, the drive clock signal SNCK set at a fixed value level LV2 is output, as indicated by B9 in FIG. 6. Specifically, the fixed value level of the drive clock signal SNCK changes from LV1 to LV2. The voltage levels of the fixed value levels LV1 and LV2 can be set at arbitrary levels using a register or the like.

The drive clock signal SNCK can be set at an arbitrary DC level in an arbitrary period when driving the image sensor by setting the drive clock signal SNCK at the fixed value level, whereby the image sensor can be appropriately driven.

The drive clock signal with various output patterns which differ depending on the image sensor can be efficiently generated and output using a simple and small circuit configuration by generating the above-described clock control signal SNCKCTL and controlling the output state of the drive clock signal SNCK.

6. Generation of Black Reference Pixel/White Pixel Indication Signal

In this embodiment, the event information memory 90 stores the change event occurrence information relating to a black reference pixel indication signal OBPIX and a white pixel indication signal WHPIX, as shown in FIG. 4. The control signal output circuit 70 generates the black reference pixel indication signal OBPIX and the white pixel indication signal WHPIX based on the change event occurrence information read from the event information memory 90, and outputs the generated signals.

As shown in FIG. 4, the black reference pixel indication signal OBPIX is set at “1” at the address 0x04 where the pixel number is set at 0x00002, for example. When the signal OBPIX is set at “01”, the pixel position is specified at the position of the black reference pixel, as indicated by B5 in FIG. 6.

The white pixel indication signal WHPIX is set at “1” at the address 0x0A where the pixel number is set at 0x00005. When the signal WHPIX is set at “01”, the pixel position is specified at the position of the white pixel (effective pixel), as indicated by B6 in FIG. 6.

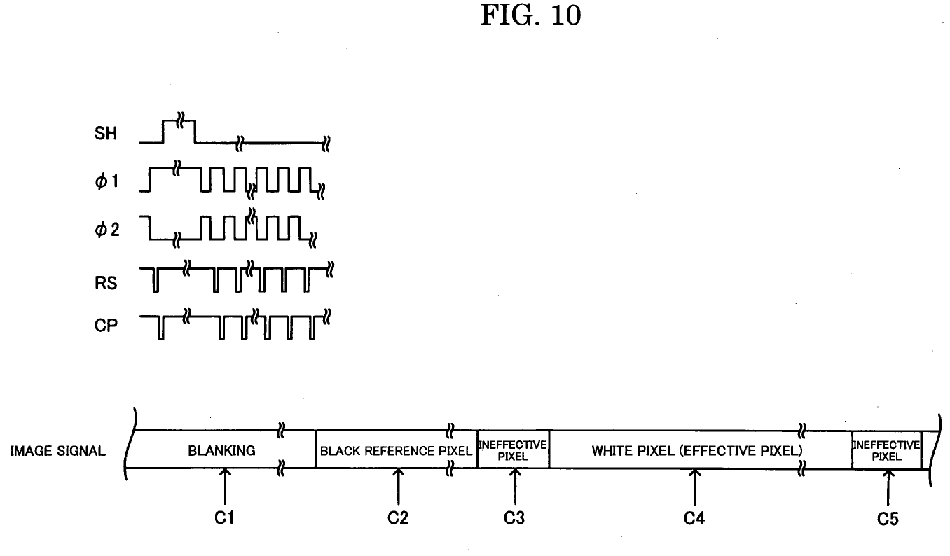

FIG. 10 schematically shows the signal waveforms of the drive clock signal (e.g., φ1 and φ2) supplied to the image sensor and an output image signal.

A blanking period occurs, as indicated by C1 in FIG. 10. An image signal of the black reference pixel (optical black or optical shield output) is then output, as indicated by C2. An image signal of the ineffective pixel is then output, as indicated by C3. An image signal of the white pixel (effective pixel) is then output, as indicated by C4. An image signal of the ineffective pixel is then output, as indicated by C5.

Therefore, the image sensor can be efficiently driven by specifying the black reference pixel position indicated by C2 in FIG. 10 and the white pixel position indicated by C4 using the black reference pixel indication signal OBPIX and the white pixel indication signal WHPIX.

The drive clock signal SNCK (φ1 and φ2) with a normal-state clock signal pattern described with reference to B5 and B6 in FIG. 6 is supplied for the black reference pixel and the white pixel indicated by C2 and C4 in FIG. 10, and the drive clock signal SNCK with a skip-state clock signal pattern described with reference to B7 in FIG. 6 is supplied for the ineffective pixel indicated by C3 and C5 in FIG. 10.

7. Control Signal Output Circuit

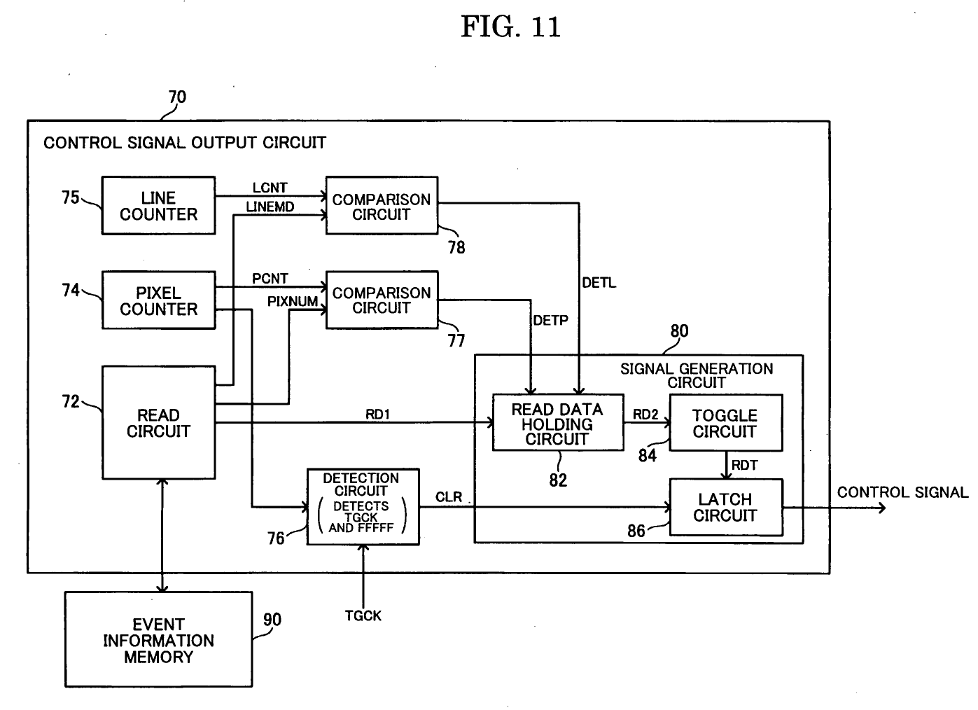

FIG. 11 shows a specific configuration example of the control signal output circuit 70. The control signal generation circuit 70 includes a read circuit 72, a pixel counter 74, a line counter 75, a detection circuit 76, comparison circuits 77 and 78, and a signal generation circuit 80. The signal generation circuit 80 includes a read data holding circuit 82, a toggle circuit 84, and a latch circuit 86. The control signal generation circuit 70 is not limited to the configuration shown in FIG. 11. Various modifications and variations may be made such as omitting some elements (e.g., line counter and comparison circuit 78) or adding other elements.

In FIG. 11, the read circuit 72 reads the pixel number and the change event occurrence information from the event information memory 90. The pixel counter 74 counts the pixel count value (see FIG. 6). The line counter 75 counts the line count value.

The comparison circuit 77 compares the pixel number PIXNUM read from the event information memory 90 through the read circuit 72 with a pixel count value PCNT outputs from the image counter 74. When the pixel number PIXNUM coincides with the pixel count value PCNT, the comparison circuit 77 outputs a coincidence detection signal DETP.

The comparison circuit 78 compares the line number LINEMD read from the event information memory 90 with a line count value LCNT output from the line counter 75. When the line number LINEMD coincides with the line count value LCNT, the comparison circuit 78 outputs a coincidence detection signal DETL.

When the pixel number PIXNUM coincides with the pixel count value PCNT and the coincidence detection signal DETP has become active, the signal generation circuit 80 generates the control signal based on the change event occurrence information stored at the address of the pixel number which coincides with the pixel count value PCNT.

Specifically, data RD1 (change event occurrence information) read from the event information memory 90 by the read circuit 72 is held by the read data holding circuit 82 at a timing when the coincidence detection signal DETP (or DETL) from the comparison circuit 77 has become active. The toggle circuit 84 toggles the control signal of which the signal level is held by the latch circuit 86 based on output data RD2 from the read data holding circuit 82. This makes it possible to generate the control signals SH1 to SH6, SHX, and the like shown in FIG. 6.

The detection circuit 76 detects the trigger signal TGCK, the finish indication information (0xFFFFF) described with reference to FIG. 4, and the like to generate the clear signal CLR described with reference to FIG. 7. When the clear signal CLR has become active, the control signal is cleared to the L level, for example.

8. Analog Processing Circuit

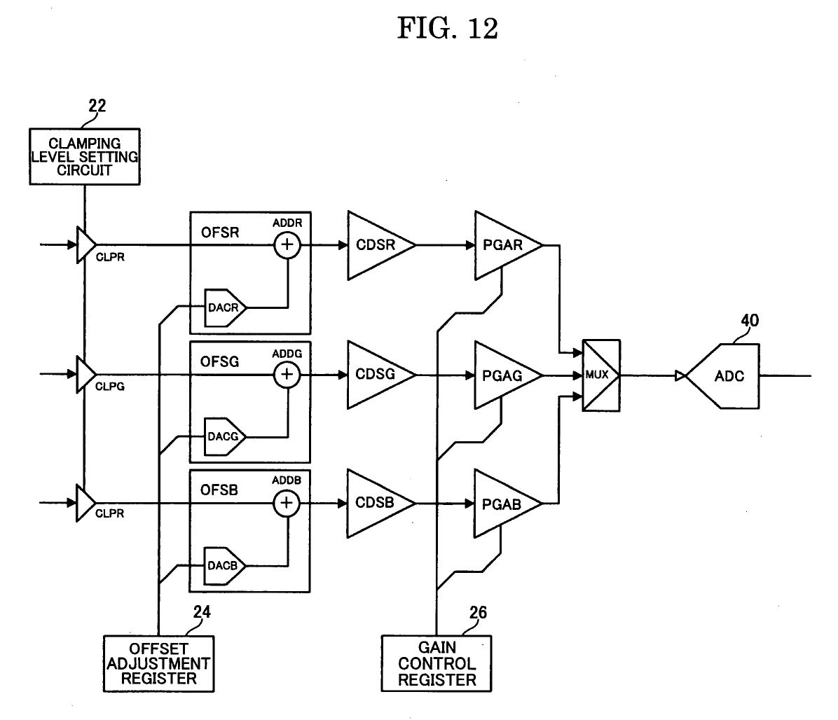

FIG. 12 shows a configuration example of the analog processing circuit 20. The analog processing circuit 20 is not limited to the configuration shown in FIG. 12. Various modifications and variations may be made such as omitting some elements.

The analog processing circuit 20 includes R, G, and B clamping circuits CLPR, CLPG, and CLPB. The clamping circuits CLPR, CLPG, and CLPB clamp the levels of R, G; and B image signals at clamping levels set by a clamping level setting circuit 22.

The analog processing circuit 20 also includes R, G, and B offset adjustment circuits OFSR, OFSG, and OFSB. The offset adjustment circuits OFSR, OFSG, and OFSB respectively include R, G; and B D/A converters DACR, DACG, and DACB and analog adder circuits ADDR, ADDG; and ADDB. The offset adjustment circuits OFSR, OFSG; and OFSB adjust an offset based on offset adjustment data set in an offset adjustment register 24.

The analog processing circuit 20 also includes R, G, and B correlated double sampling circuits CDSR, CDSG, and CDSB. The analog processing circuit 20 also includes R, G, and B gain control amplifiers PGAR, PGAG; and PGAB. The gain control amplifiers PGAR, PGAG, and PGAB perform gain control based on gain control data set in a gain control register 26.

The analog processing circuit 20 also includes a multiplexer MUX. The R, G, and B image signals can be A/D-converted by time division using the high-speed A/D converter 40 by providing the multiplexer MUX.

9. Electronic Instrument

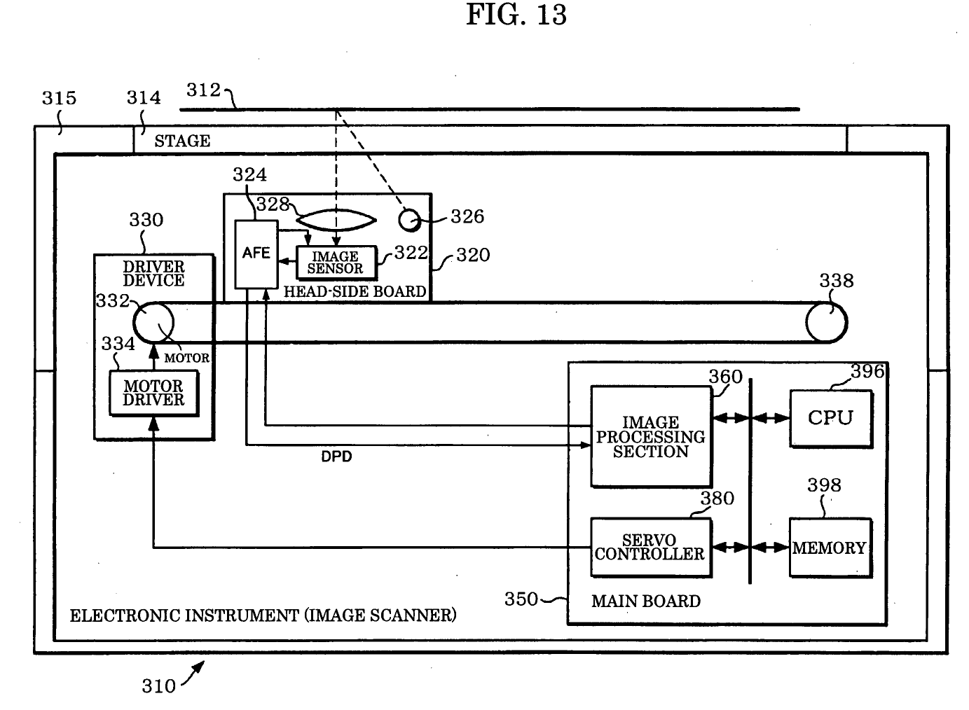

FIG. 13 shows a configuration example of an electronic instrument 310 including an analog front-end circuit (AFE) 324 according to one embodiment of the invention. The electronic instrument 310 need not necessarily include all the elements shown in FIG. 13. Various modifications and variations may be made such as omitting some elements.

The analog front-end circuit 324 may be realized by a semiconductor device (integrated circuit device) including the analog front-end circuit 324 and the other circuit such as a control circuit, CPU, and the like.

The electronic instrument 310 (e.g., flatbed image scanner) includes a stage 314 on which an object 312 (e.g., document) is placed, and a frame 315 (e.g., support member or housing) which supports the stage 314. The rectangular stage 314 is formed of an optically transparent material such as glass. The object 312 is placed on the upper portion of the optically transparent stage 314, for example.

The electronic instrument 310 includes a head-side board (carriage) 320 provided with an image sensor 322 and the analog front-end circuit 324. As the image sensor 322, a charge coupled device (CCD), a contact image sensor (CIS), a bucket brigade device (BBD) or the like may be used. The head-side board 320 is also provided with a light source 326 which illuminates the object 312 (document), and an optical system (optical head) such as a lens 328 (condensing section) which focuses light emitted from the light source 326 and reflected by the object 312 on the image sensor 322.

The electronic instrument 310 includes a driver device 330 (drive mechanism) which moves the head-side board 320. The driver device 330 includes a motor 332 (power source) and a motor driver 334 which drives the motor 332. The image sensor 322 is disposed so that the longitudinal direction coincides with the main scan direction. A drive belt which is supported by a pulley 338 on the other end is driven by the motor 332 so that the head-side board 320 secured on the drive belt moves in the sub-scan direction (direction perpendicular to the main scan direction). The method of moving the head-side board 320 may be modified in various ways.

The electronic instrument 310 includes a main board 350. The main board 350 controls each block of the electronic instrument 310. Specifically, the main board 350 controls an image data acquisition process, a servomechanism of the head-side board 320, the analog front-end circuit 324, and the like.

The main board 350 includes an image processing section 360. The image processing section 360 processes image data acquired by the analog front-end circuit 324. The main board 50 includes a servo controller 380. The servo controller 380 performs servo control (feedback control) of the driver device 330 (motor 32) which drives (moves) the head-side board 320. The main board 350 includes a CPU 396 (processor) and a memory 398 (ROM and RAM). The CPU 396 controls the entire main board 350, and exchanges information with the outside. The memory 398 stores a program and various types of data, and functions as a work area for the image processing section 360, the servo controller 380, and the CPU 396.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term cited with a different term having a broader meaning or the same meaning at least once in the specification and the drawings can be replaced by the different term in any place in the specification and the drawings. The configurations and the operations of the analog front-end circuit and the electronic instrument are not limited to those described in the above embodiments. Various modifications and variations may be made.

What is claimed is:

1. An analog front-end circuit comprising:
an analog processing circuit that receives an analog input image signal from an image sensor, performs a given process on the analog input image signal, and outputs an analog image signal;
an A/D converter that A/D-converts the analog image signal output from the analog processing circuit; and
a timing generator that generates a plurality of control signals that are supplied to the image sensor,
the timing generator including:
an event information memory; and
a control signal output circuit that generates the plurality of control signals based on information read from the event information memory, and outputs the plurality of control signals that have been generated,
the event information memory storing a pixel number and change event occurrence information at each address, the change event occurrence information specifying a control signal among the plurality of control signals that undergoes a signal level change event at the pixel number; and
the control signal output circuit generating the plurality of control signals based on the pixel number and the change event occurrence information read from the event information memory, and outputting the plurality of control signals that have been generated.

2. The analog front-end circuit as defined in claim 1, the pixel number being allocated to first to Lth bits of data stored at each address of the event information memory, and the change event occurrence information being allocated to (L+1)th to Mth (L<M; L and M are natural numbers) bits of the data stored at each address of the event information memory.

3. The analog front-end circuit as defined in claim 2, first to (M-L)th control signals among the plurality of control signals being respectively allocated to the (L+1)th to Mth bits of the data stored at each address of the event information memory.

4. The analog front-end circuit as defined in claim 3, when an Nth (L+1≦N≦M; L, N, and M are natural numbers) bit of the (L+1)th to Mth bits is set at a first logic level, the control signal output circuit toggling a signal level of a control signal among the plurality of control signals that is allocated to the Nth bit.

5. The analog front-end circuit as defined in claim 1, the control signal output circuit sequentially reading the pixel number and the change event occurrence information in an order from a head address to an end address of the event information memory, and returning a read pointer of the event information memory to the head address before the end address is reached when at least one of the pixel number and the change event occurrence information that have been read is set to finish indication information that indicates that the change event has finished.

6. The analog front-end circuit as defined in claim 1, the control signal output circuit sequentially reading the pixel number and the change event occurrence information in an order from a head address to an end address of the event information memory, and returning a read pointer of the event information memory to the head address when the end address has been reached.

7. The analog front-end circuit as defined in claim 5,
the event information memory storing toggle indication information as the change event occurrence information, the toggle indication information indicating to toggle a signal level of a control signal among the plurality of control signals; and
the control signal output circuit clearing signal levels of the plurality of control signals to a first signal level when the read pointer has been returned to the head address and processing of pixels of a next line starts.

8. The analog front-end circuit as defined in claim 6,
the event information memory storing toggle indication information as the change event occurrence information, the toggle indication information indicating to toggle a signal level of a control signal among the plurality of control signals; and
the control signal output circuit clearing signal levels of the plurality of control signals to a first signal level when the read pointer has been returned to the head address and processing of pixels of a next line starts.

9. The analog front-end circuit as defined in claim 1,
the event information memory storing change event occurrence information relating to a shift signal that causes a transfer gate of the image sensor to be turned ON; and
the control signal output circuit generating the shift signal based on the change event occurrence information relating to the shift signal that has been read from the event information memory, and outputting the shift signal that has been generated.

10. The analog front-end circuit as defined in claim 1,
the control signal output circuit generating a drive clock signal that is used to drive the image sensor, and outputting the drive clock signal that has been generated;
the event information memory storing change event occurrence information relating to a clock control signal that controls an output state of the drive clock signal; and
the control signal output circuit generating the clock control signal based on the change event occurrence information relating to the clock control signal that has been read from the event information memory, and controlling the output state of the drive clock signal based on the clock control signal that has been generated.

11. The analog front-end circuit as defined in claim 10, the control signal output circuit outputting the drive clock signal with a normal-state clock signal pattern when the clock control signal is set in a first state, and outputting the drive clock signal with a skip-state clock signal pattern when the clock control signal is set in a second state.

12. The analog front-end circuit as defined in claim 10, the control signal output circuit outputting the drive clock signal with a normal-state clock signal pattern when the clock control signal is set in a first state, and outputting the drive clock signal set at a fixed value level when the clock control signal is set in a third state.

13. The analog front-end circuit as defined in claim 11, the control signal output circuit outputting the drive clock signal with the normal-state clock signal pattern when the clock control signal is set in the first state, and outputting the drive clock signal set at a fixed value level when the clock control signal is set in a third state.

14. The analog front-end circuit as defined in claim 1,
the event information memory storing change event occurrence information relating to a black reference pixel indication signal that specifies a position of a black reference pixel of the image sensor; and
the control signal output circuit generating the black reference pixel indication signal based on the change event occurrence information relating to the black reference pixel indication signal that has been read from the event information memory, and outputting the black reference pixel indication signal that has been generated.

15. The analog front-end circuit as defined in claim 1,
the event information memory storing change event occurrence information relating to a white pixel indication signal that specifies a position of a white pixel of the image sensor; and
the control signal output circuit generating the white pixel indication signal based on the change event occurrence information relating to the white pixel indication signal that has been read from the event information memory, and outputting the white pixel indication signal that has been generated.

16. The analog front-end circuit as defined in claim 1,
the control signal output circuit including:
a pixel counter that counts a pixel count value;
a comparison circuit that compares the pixel number read from the event information memory with the pixel count value output from the pixel counter; and
a signal generation circuit that generates the plurality of control signals when the pixel number coincides with the pixel count value, the signal generation circuit generating the plurality of control signals based on the change event occurrence information stored at an address of the pixel number that coincides with the pixel count value.

17. A semiconductor device comprising the analog front-end circuit as defined in claim 1.

18. An electronic instrument comprising:
the analog front-end circuit as defined in claim 1; and
an image sensor.

19. An electronic instrument comprising:
a head-side board provided with the analog front-end circuit as defined in claim 1 and an image sensor; and
a main board provided with an image processing section that processes digital image data output from the analog front-end circuit.
